(19) United States
(12) Patent Application Publication
(10) Pub. No.: US 2009/0212515 A1
(43) Pub. Date: Aug. 27, 2009

(54) Collapsible Trailer for Vehicle

(76) Inventor: Eirik Øyasaeter, Hovik (NO)

Correspondence Address: LADAS & PARRY LLP, 26 WEST 61ST STREET, NEW YORK, NY, 10023, US

(21) Appl. No.: 11/887,807

(22) PCT Filed: Apr. 5, 2006
(86) PCT No.: PCT/NO2006/000126

§ 371 Date: Dec. 4, 2008

(30) Foreign Application Priority Data
Apr. 8, 2005 (NO) 2005 1735

(51) Int. Cl. B62D 33/08

(52) U.S. Cl. 280/40

(57) ABSTRACT

Collapsible trailer for vehicle where the sidewalls/frames (3a, 3b) can be fold inwards on top of the cargo surface (2), tele-scopic draw (4) can be pushed into the frame (1). The axel (6) between the wheels (7) can be disconnected from the wheel suspension (5) with wheel (7) can be turned flush with the underside of the trailer. The stopper(s) (10a, 10b) is (are) included and prevent(s) the wheel suspension (5) and wheel (7) to travel out of the calculated width. At least two smaller wheels (11) substantially in vertical position in the underside of the trailer ease the relocation of the trailer in upright, collapsed position.

The invention concerns a collapsible trailer for vehicle. This is basically an ordinary trailer for vehicle which in a simple way can be folded to a flat package for space saving storage. In collapsed (folded) condition the trailer will require minimal storage room and for example could be positioned vertically on edge along the inside of a garage wall etc.

Previously a number of solutions have been suggested for the same problem. Some of the solutions include that only side walls/frames, draw or bottom can be folded together. Other solutions show that the trailer can be positioned on edge and that the wheels can be “hoisted up” vertically on level with the trailer box.

References are here made to the patented solutions U.S. Pat. No. 4.362.316, U.S. Pat. No. 4.480.851, U.S. Pat. No. 6.010.145, U.S. Pat. No. 2.720.413.

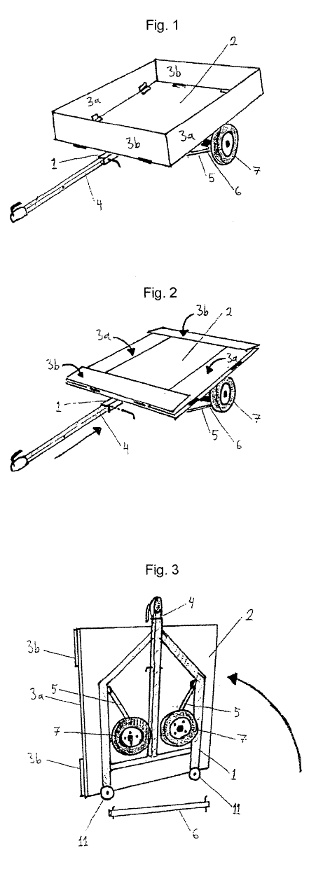

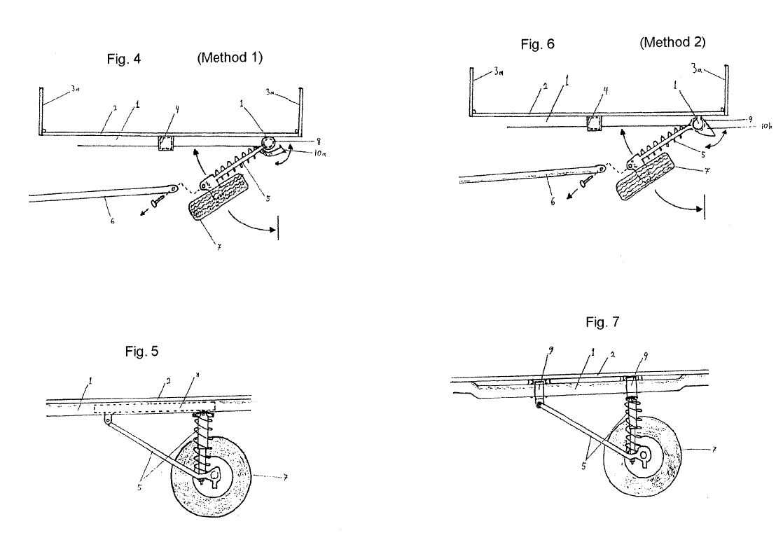

Reference is made to the figures which depict the below discussed details: FIG. 1 depicts the trailer before collapsing. FIG. 2 depicts collapsing of side walls/frames (3a/3b) against the middle part and the draw (4) is pushed in. FIG. 3 depicts the trailer completely collapsed and located on edge. The axel (6) is here dismounted from the wheels (7) and turned flush with the underside of the trailer (2). FIGS. 4, 5, 6 and 7 show two different methods for putting in wheel suspension (5) with the wheel (7). FIGS. 4 and 5 show Method 1 seen from the front and from the side, respectively. FIGS. 6 and 7 show Method 2 correspondingly.

### Novelties in relation to the prior art technique:

A new way to put together (collapse) a trailer with commonly known telescopic draw (4) which can be pushed in, side walls/frames (3a, 3b) which can be folded down, axel which can be dismounted and insertable wheel suspension (5). The invention goes further with regard to functionality than previous solutions and makes the trailer to a less space requiring flat package in collapsed state. The trailer consists of a frame/a chassis (1) which is mounted to a cargo surface (2). To this cargo surface (2) sidewalls/frames (3a, 3b) are mounted which can be folded inwards on top of the cargo surface (2). The draw (4) is made telescopically and can be pushed into the frame (1). The wheels are connected to commonly known wheel suspension (5) consisting of hub, springs and possible bridge and shock absorber. The axel (6) between the wheels (7) can be dismounted by means of locking-/fastening device(s), and the wheels (7) can be turned flush with the underside of a trailer (2).

Putting in wheel, Method 1, FIG. 4: This is carried out in that the wheel suspension (5) at the upper part is mounted to a pipe/bearing (8), which is located pivotally within the frame (1). A physical stopper (10a) prevents the wheel suspension (5) to travel out of the calculated track width.

Putting in wheel, Method 2, FIG. 5: This is carried out in that the wheel suspension (5) at the upper part is mounted to a pipe/bearing (9), which is pivotably located inside the frame (1). A physical stopper (10b) prevents the wheel suspension (5) from travelling out of the calculated track width.

In collapsed upright position at least two small wheels (11) substantially provided in vertical position in the lower edge of the trailer will ease the relocation.

1. Collapsible trailer for vehicle, in the form that walls/frames (3a, 3b) can be collapsed inwards on a cargo surface (2) and that this one has a draw (4) which can telescopically be pushed in, characterized in that it between two or several wheels (7) can be used axel(s) (6) which is (are) demounted and that wheel (7) with wheel suspension (5) is mounted to a pipe/bearing (8, 9) pivotally provided inside or outside a frame (1), and the wheel suspension (5) is turned flush with the underside of the trailer.

2. Collapsible trailer for vehicle according to claim 1, characterized in that one or several stoppers (10a, 10b) is (are) located one the wheel suspension (5).

3. Collapsible trailer for vehicle according to claim 1, characterized in that at least two wheels (11) are arranged substantially in vertical position in the lower edge of the trailer in upright position.

4. Collapsible trailer for vehicle according to claim 1, characterized in that one or several axel(s) (6) is (are) lock-/connectable by means of locking-/fastening device(s).
